(19) United States
(12) Patent Application Publication
(10) Pub. No.: US 2025/0236538 A1
(43) Pub. Date: Jul. 24, 2025

(54) Ammonia-driven hydrogel dehydration-desalination method

(71) Applicant: FUDAN UNIVERSITY, Shanghai (CN)

(72) Inventors: Xiuping ZHU, Shanghai (CN); Jingyuan FEI, Shanghai (CN)

(73) Assignee: FUDAN UNIVERSITY, Shanghai (CN)

(21) Appl. No.: 18/972,338

(22) Filed: Dec. 6, 2024

(30) Foreign Application Priority Data
Jan. 23, 2024 (CN) 202410094370.X

(51) Int. Cl. C02F 1/26; C02F 1/44; C02F 101/12; C02F 103/08

(52) U.S. Cl. CPC C02F 1/265; C02F 1/441; C02F 2101/12; C02F 2103/08

(57) ABSTRACT

An ammonia-driven hydrogel dehydration-desalination method is provided. The method includes the following steps: a hydrogel soaking step: soaking a hydrogel in salt water; and an ammonia dehydration step: placing the hydrogel after water absorption in a closed container, and introducing ammonia for making the ammonia dissolved on a surface of the hydrogel to produce a high osmotic pressure, so as to promote the permeation of water molecules out of the hydrogel and to obtain produced water

### CROSS-REFERENCE TO RELATED APPLICATION

The present application claims priority to Chinese Patent Application No. 202410094370.X, filed with the China National Intellectual Property Administration on Jan. 23, 2024, the entire contents of which are incorporated by reference.

### FIELD

The present disclosure relates to the technical field of dehydration of hydrogels, in particular to an ammonia-driven hydrogel dehydration-desalination method.

### BACKGROUND

The scarcity of fresh water is a global problem, and hydrogels, as a kind of three-dimensional crosslinked polymers, have been widely used in fields with a strong water absorption ability due to hydrophilic network structures. The hydrogels not only have been used in the terms of baby diapers, biosensors, soil moisturizers, wound dressings, etc., but also have been widely studied in environmental fields, such as carbon dioxide capture, heavy metal adsorption, salinity gradient energy recovery, seawater desalination, and brackish water desalination, etc. In the term of desalination of seawater and brackish water, the hydrogels are mainly achieved through two ways. First, the hydrogels can be used as attractants in a positive osmotic pressure desalination (FO) process. Water flows are pushed to pass through semi-permeable membranes and enter the hydrogels through a high osmotic pressure produced by ionic groups in the hydrogels, and then absorbed water is recovered through dehydration under appropriate conditions. Second, the hydrogels can be directly used as desalination media. When the hydrogels are placed in salt water, charged groups and electrically neutral constraints in the hydrogels repel salt ions, leading to a lower concentration of salt ions in the hydrogels than surrounding solutions and being accordance with a Donnan equilibrium theory. Subsequently, external physical or chemical stimulations, such as mechanical extrusion, heating, electric fields, and solar evaporation, etc., are used for dehydrating and recovering water and reusing the hydrogels. However, these methods usually lead to a water recovery rate of lower than 75% or exhibit low stability after few cycles due to irreversible damage to the structures of the hydrogels. The hydrogels are used for desalination due to an excellent water absorption ability and response properties to stimulations. However, it is still a great challenge to recover water by a simple and repeatable manner.

### SUMMARY

In order to overcome the above disadvantages of the prior art, the purpose of the present disclosure is to provide an ammonia-driven hydrogel dehydration-desalination method, which is a novel method for dehydration of hydrogels by using ammonia. The ammonia has high permeation efficiency, namely high solubility in water and a relatively low molecular weight, so as to produce a high osmotic pressure. In addition, the ammonia can be easily and cheaply separated from produced water by distillation, gas purging, or stirring evaporation and other manners without being consumed in a process. An excellent water recovery property is achieved by introducing the ammonia into a poly(acrylic acid-co-acrylamide) (P(AA-co-AM)) hydrogel with a superior water absorption ability. By using the method, maximum water production at salt concentrations of 15 g/L and 30 g/L is 1,140 and 600 L_{H2O}/kg_{hydrogel}/day, respectively.

The purpose of the present disclosure can be realized through the following technical solutions.

The purpose of the present disclosure is to provide an ammonia-driven hydrogel dehydration-desalination method, including the following steps:
a hydrogel soaking step: soaking a hydrogel in salt water; and
an ammonia dehydration step: placing the hydrogel after water absorption in a closed container, and introducing ammonia for making the ammonia dissolved on a surface of the hydrogel to produce a high osmotic pressure, so as to promote the permeation of water molecules out of the hydrogel and to obtain produced water after desalination.

Further, the hydrogel is a poly(acrylic acid-co-acrylamide) hydrogel; and the poly(acrylic acid-co-acrylamide) hydrogel is synthesized by an in-situ solution polymerization method.

Further, the hydrogel exhibits excellent water absorption and dehydration properties in water with a salt concentration of 15-30 g/L.

Further, the salt water is water (a sodium chloride solution) with a salt concentration of 15-30 g/L or real seawater.

Further, reaction conditions for synthesizing the hydrogel are as follows: concentrations of monomers: acrylic acid: 140-160 g/L, and acrylamide: 20-30 g/L; a reaction time: 4 h; a reaction temperature: 70° C.; and a neutralization degree of the acrylic acid monomer: 60 mol %.

Further, a synthesis process of the hydrogel is specifically as follows:
(1) First, an acrylic acid solution with a neutralization degree close to 60 mol % is prepared. 10 mL (4.25 mol/LNaOH) of a sodium hydroxide solution is slowly added to 5 mL of acrylic acid, and fully stirred under an ice bath to reach a neutralization degree of 60 mol %.
(2) Then, a mixed solution of acrylamide, N,N′-methylene diacrylamide (1 g/L), and ammonium persulfate is prepared. 1.2 mL (1 g/L) of an N,N′-methylene diacrylamide aqueous solution, 2.9 mL (2 g/L) of an ammonium persulfate aqueous solution, and 0.83 g of acrylamide are dissolved in 17.5 mL of deionized water, and magnetically stirred for 5 min to fully mix the solutions.
(3) Under the condition of a constant flow of nitrogen, the solution obtained in step (2) is dropped into the solution obtained in step (1), and magnetically stirred for 30 min to fully mix the solutions.
(4) A mixed solution obtained in step (3) is sealed to be isolated from the air, placed in a constant-temperature water bath at 70° C., and heated for 4 h to ensure a full free radical polymerization reaction. Finally, a synthesized hydrogel material is taken out, fully cleaned with deionized water, and then placed in an oven for complete drying at 70° C. for 24 h.

Further, by adjusting the reaction conditions, including the concentrations of monomers, the reaction time, the reaction temperature, and the neutralization degree of the acrylic acid monomer, etc., the structure and crosslinking density of the hydrogel can be adjusted, such that the hydrogel has a better water absorption property and a desalination property in water with different salt concentrations.

Further, in a water absorption process of the hydrogel achieves a salt rejection rate of 60% or above through electrostatic repulsion of carboxylate ions in the hydrogel. One monomer (acrylic acid) of the hydrogel is neutralized with an appropriate amount of a NaOH solution before a crosslinking reaction, such that the neutralization degree of the acrylic acid monomer is 60 mol %. At this time, 60 mol % of carboxyl (—COOH) in the acrylic acid monomer is converted into the form of —COO⁻Na⁺, Na⁺ ions are freed after the hydrogel absorbs water, and thus the hydrogel itself has carboxylate anions (—COO⁻).

Further, in the ammonia dehydration step, the ammonia is introduced at a rate of 1 L/min; and the ammonia is introduced for a time of 30 min.

Further, in the ammonia dehydration step, a water recovery rate is higher than 90%.

Further, by adjusting the ammonia introduction rate and time, the water recovery rate of higher than 90% is achieved. Meanwhile, through the electrostatic repulsion of the carboxylate ions in the hydrogel, the salt rejection rate of up to 60% or above is achieved.

Further, in the ammonia-driven hydrogel dehydration-desalination method, the hydrogel is soaked in water with a salt concentration of 15 g/L, and the maximum water production in the ammonia dehydration step is 1,140 L_{H2O}/kg_{hydrogel}/day.

Further, in the ammonia-driven hydrogel dehydration-desalination method, the hydrogel is soaked in water with a salt concentration of 30 g/L, and the maximum water production in the ammonia dehydration step is 600 L_{H2O}/kg_{hydrogel}/day.

Further, in the ammonia-driven hydrogel dehydration-desalination method, stable properties are maintained in 100 consecutive water absorption-dehydration cycles, and the water recovery rate and the salt rejection rate are not obviously changed. One water absorption-dehydration cycle includes one time of hydrogel soaking (4 h) and one time of ammonia dehydration (1 h).

Further, in the ammonia dehydration step, the resulting produced water after desalination is used for plant irrigation.

Further, the ammonia-driven hydrogel dehydration-desalination method is integrated with a reverse osmosis system to achieve a seawater desalination process.

Compared with the prior art, the present disclosure has the following beneficial effects.
(1) The ammonia-driven hydrogel dehydration-desalination method provided by the present disclosure achieves a significant dehydration effect through tests in synthetic seawater and real seawater, and the water recovery rate is higher than 90% and shows high stability in 100 water absorption-dehydration cycles, which is obviously higher than recovery rates of other methods for dehydration of hydrogels on the market at present.
(2) According to the ammonia-driven hydrogel dehydration-desalination method provided by the present disclosure, a hydrogel dehydration-desalination system is extremely stable, the water recovery rate and the salt rejection rate are not obviously changed after 100 water absorption-dehydration cycles, and the method provides an innovative way for efficient water production and desalination of hydrogel materials and has a wide practical application prospect.

### BRIEF DESCRIPTION OF DRAWINGS

FIG. 1 is a schematic diagram of a water absorption-dehydration mechanism of an ammonia-driven hydrogel dehydration-desalination method of the present disclosure.

FIG. 2 shows change trends of the swelling rate of hydrogels of the ammonia-driven hydrogel dehydration-desalination method of the present disclosure in salt water with different concentrations in a water absorption process with time (a); change trends of the swelling rate of hydrogels in salt water with different concentrations in a dehydration process with time (b); dehydration effects (the water recovery rate and salt rejection rate) of hydrogels at different ammonia flow rates (c); and the water production rate, water recovery rate and salt rejection rate of hydrogels in salt water with different concentrations and real seawater (d).

FIG. 3 shows stability test results of hydrogels of the ammonia-driven hydrogel dehydration-desalination method of the present disclosure in synthetic seawater (3a) of a 30 g/L sodium chloride solution and real seawater (3b) after 100 consecutive water absorption-dehydration cycles.

FIG. 4 shows scanning electron microscope comparison images of the effect of the ammonia-driven hydrogel dehydration-desalination method of the present disclosure on structures of hydrogels ((a-c) show the surface morphology of the hydrogels after freeze-drying; and (d-f) show pore structures of sections of the hydrogels after freeze-drying), wherein (a) and (d) show the hydrogels directly freeze-dried after water absorption in ultrapure water; (b) and (e) show the hydrogels freeze-dried after 100 water absorption-dehydration cycles using a 30 g/L sodium chloride solution (synthetic seawater); and (c) and (f) show the hydrogels freeze-dried after 100 water absorption-dehydration cycles using real seawater.

FIG. 5 is a mixing schematic diagram of mixing a product (water) of the ammonia-driven hydrogel dehydration-desalination method with a reverse osmosis system.

### DESCRIPTION OF EMBODIMENTS

The present disclosure is described in detail below in combination with accompanying drawings and specific embodiments. Features, such as model numbers of parts, material names, connection structures, control methods, etc., that are not clearly stated in the technical solutions are regarded as common technical features disclosed in the prior art.

Raw materials in the following embodiments are commercially available products or purchased products.

### Embodiment

An ammonia-driven hydrogel dehydration-desalination method of the present embodiment is used for efficient desalination of seawater and brackish water.

The ammonia-driven hydrogel dehydration-desalination method includes the following steps.

### 1) Synthesis of Hydrogels

First, poly(acrylic acid-co-acrylamide) (P(AA-co-AM)) hydrogels with an excellent water absorption property are synthesized by an in-situ solution polymerization method. By controlling appropriate reaction conditions, such as temperature, pressure, and reaction time, structures and properties of the hydrogels can be adjusted.

A specific synthesis flow of the hydrogels is as follows:
(1) First, an acrylic acid solution with a neutralization degree close to 60 mol % is prepared. 10 mL (4.25 mol/LNaOH) of a sodium hydroxide solution is slowly added to 5 mL of acrylic acid, and fully stirred under an ice bath to reach a neutralization degree of 60 mol %.
(2) Then, a mixed solution of acrylamide, N,N′-methylene diacrylamide (1 g/L), and ammonium persulfate is prepared. 1.2 mL (1 g/L) of an N,N′-methylene diacrylamide aqueous solution, 2.9 mL (2 g/L) of an ammonium persulfate aqueous solution, and 0.83 g of acrylamide are dissolved in 17.5 mL of deionized water, and magnetically stirred for 5 min to fully mix the solutions.
(3) Under the condition of a constant flow of nitrogen, the solution obtained in step (2) is dropped into the solution obtained in step (1), and magnetically stirred for 30 min to fully mix the solutions.
(4) A mixed solution obtained in step (3) is sealed to be isolated from the air, placed in a constant-temperature water bath at 70° C., and heated for 4 h to ensure a full free radical polymerization reaction. Finally, synthesized hydrogel materials are taken out, fully cleaned with deionized water, and then placed in an oven for complete drying at 70° C. for 24 h.
   2) Test of a Water Absorption Property of Hydrogels in Salt Water with Different Concentrations and Components

Synthesized P(AA-co-AM) hydrogels are soaked in water with different salt concentrations, including 15 to 30 g/L of salt water and real seawater (natural seawater is used as the real seawater, sampled at 29° 12′13.2″N 90° 02′08.4″W), specifically, 15 g/L of a sodium chloride solution, 20 g/L of a sodium chloride solution, 30 g/L of a sodium chloride solution, and real seawater. Rapid absorption of water by the hydrogels is observed. Especially under the condition of low salt concentrations, the hydrogels exhibit faster water absorption kinetics.

### 3) Test of a Dehydration Property of an Ammonia-Driven Hydrogel Dehydration System

Hydrogels after water absorption are placed in a closed container (with an ammonia inlet and an ammonia outlet), and ammonia (NH₃) is introduced. The ammonia is dissolved on surfaces of the hydrogels to produce a high osmotic pressure, so as to promote the permeation of water molecules out of the hydrogels (FIG. 1). In the process, recovered water can be collected into the container by gravity. By analyzing absorption and removal processes of the ammonia in the hydrogels, it is confirmed that the ammonia mainly promotes dehydration of the hydrogels through a high osmotic pressure way. The dissolution and diffusion of the ammonia in the hydrogels are studied in detail to ensure that structures of the hydrogels are not damaged by using the ammonia.

### 4) Test of Stability of the Water Recovery Rate and the Salt Rejection Rate

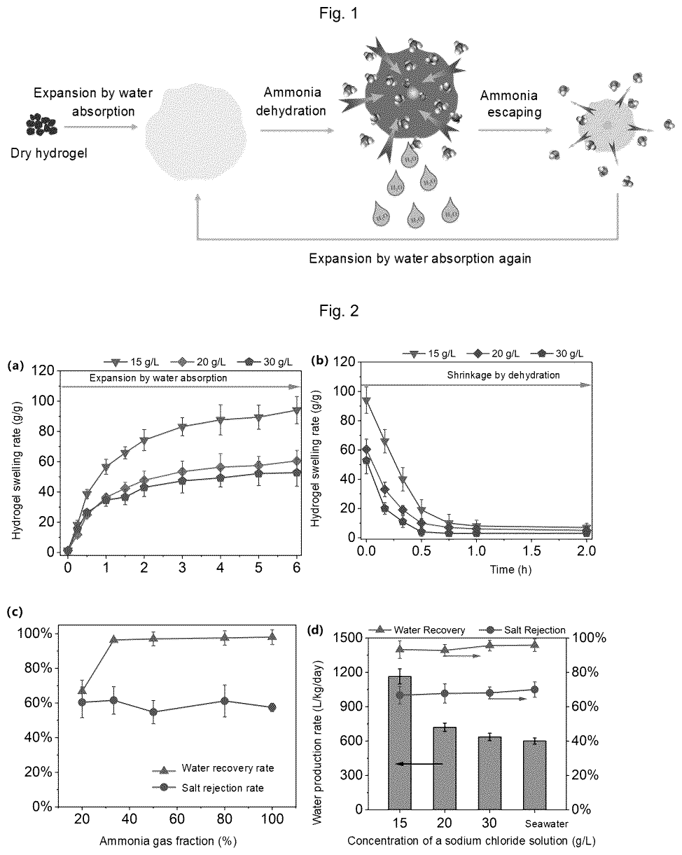

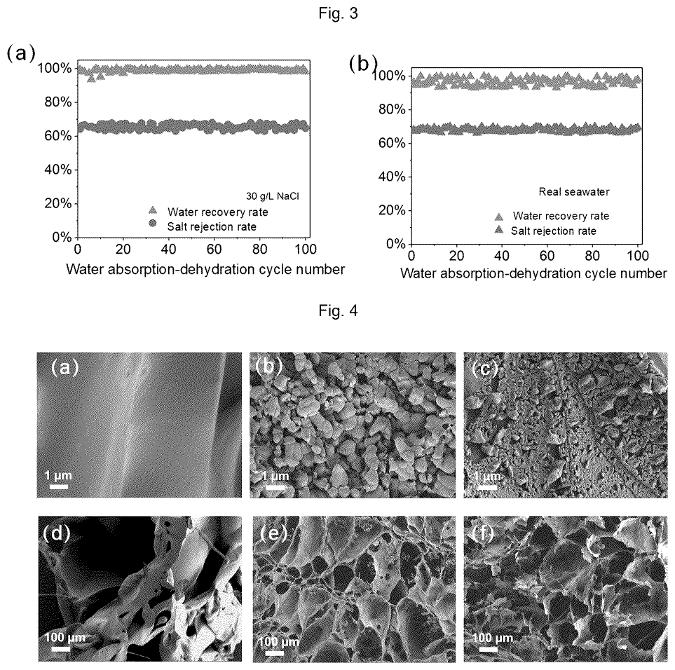

By adjusting the flow rate and time of ammonia introduced, the water recovery rate of higher than 90% can be achieved (FIGS. 2b-c), and the salt rejection rate of up to 60% or above can be achieved. After 100 consecutive water absorption-dehydration cycles in synthetic seawater (30 g/L of salt water) and real seawater, the system shows excellent stability, the water recovery rate, the salt rejection rate and internal and external structures of hydrogels are not obviously changed, the water recovery rate is maintained at 90% or above, and the salt rejection rate is maintained at 60% or above (FIG. 3, FIG. 4).

5) The dehydration time in FIG. 2b indicates that when the ammonia introduction time is 30 min, hydrogels soaked in different salinities are all close to a dehydration equilibrium. Therefore, the ammonia introduction time is selected as 30 min for all the hydrogels in a dehydration process.

6) Description of dehydration effects at different ammonia flow rates (FIG. 2c) With water absorption-dehydration of hydrogels in 30 g/L of a NaCl solution as an example, the water recovery rate and salt rejection rate of the hydrogels at different ammonia flow rates (the ammonia is introduced for 30 min) are tested in FIG. 2c. Under the condition of controlling a total gas flow rate at 2 L/min, volume fraction percentages of ammonia and nitrogen are changed, including 20:80 (vol) %, 33:67 (vol) %, 50:50 (vol) %, 80:20 (vol) %, and 100:0 (vol) %, to study the effect of the ammonia flow rate on dehydration of the hydrogels. When the ammonia gas fraction is higher than 33 (vol) % (that is, 0.67 L/min), the water recovery rate of the hydrogels is maintained at 90% or above, and the salt rejection rate is also stabilized at about 60%. Therefore, the ammonia flow rate of 1 L/min is selected as a dehydration flow rate of the hydrogels in all cases in the experiment.

7) Description of calculation of the water production (FIG. 2d) In FIG. 2d, 2 h is used as one water absorption-dehydration cycle, which includes a water absorption time of 1 h and a dehydration time of 1 h (30 min for ammonia introduction, 30 min for standing). Through the water absorption-dehydration cycle, the average water production rate of the hydrogels per day can be calculated.

### 8) Description of SEM Images (FIG. 4)

FIG. 4(a) shows the surface morphology of a hydrogel without dehydration after expansion by water absorption in deionized water. FIGS. 4(b) and (c) show the surface morphology of hydrogels after 100 consecutive water absorption-dehydration cycles in synthetic seawater with a salt concentration of 30 g/L and real seawater, respectively. FIG. 4(d) shows a pore structure of a truncated surface of the hydrogel without dehydration after expansion by water absorption in the deionized water; and FIGS. 4(e) and (f) show pore structures of truncated surfaces of the hydrogels after 100 consecutive water absorption-dehydration cycles in the synthetic seawater with a salt concentration of 30 g/L and the real seawater, respectively. Compared with the smooth surface morphology in FIG. 4(a), due to cyclic water absorption-dehydration of the hydrogels in the synthetic seawater with a salt concentration of 30 g/L and the real seawater in FIGS. 4(b) and 4(c), a layer of crystalline particles of inorganic salts are attached to the surfaces of the hydrogels after drying. Meanwhile, by comparing the truncated surfaces of the three kinds of hydrogels (FIGS. 4(d-f)), no obvious changes of the pore structures are observed. This result confirms that dehydration using the ammonia-driven hydrogels is a gentle process, which can ensure that the hydrogels maintain stable properties in multiple water absorption-dehydration cycles, and meanwhile the structural integrity of the hydrogels is maintained.

### Application Example 1

The present application example provides an application scenario of an ammonia-driven hydrogel dehydration-desalination method in production of water.

### Plant Irrigation:

Desalinated water obtained by the present disclosure can be directly used for plant irrigation. For example, a certain concentration of brackish water (equivalent to 1,000-15,000 ppm of NaCl) can be directly used for rice irrigation after one time of desalination. Specifically, a P(AA-co-AM) hydrogel is soaked in a certain concentration of brackish water (equivalent to 1,000-15,000 ppm of NaCl), the hydrogel after water absorption is placed in a closed container, and ammonia is introduced for making the ammonia dissolved on a surface of the hydrogel to produce a high osmotic pressure, so as to promote the permeation of water molecules out of the hydrogel and to obtain produced water after desalination. The obtained water can be directly used for rice irrigation to achieve development of agricultural cultivation in special areas at a low cost.

### Application Example 2

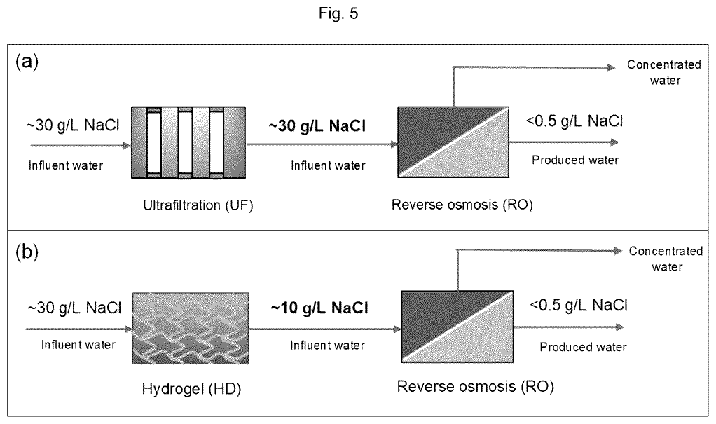

The present application example provides a method for integrating an ammonia-driven hydrogel dehydration-desalination method with a reverse osmosis system to further reduce energy consumption and a total cost. By mixing a product (water) of the ammonia-driven hydrogel dehydration-desalination method with the reverse osmosis system (a mixing schematic diagram is shown in FIG. 5), water purification efficiency can be significantly improved, and energy consumption of an overall desalination process can be reduced.

What is claimed is:

1. An ammonia-driven hydrogel dehydration-desalination method, wherein the method comprises the following steps:
a hydrogel soaking step: soaking a hydrogel in salt water; and
an ammonia dehydration step: placing the hydrogel after water absorption in a closed container, and introducing ammonia for making the ammonia dissolved on a surface of the hydrogel to produce a high osmotic pressure, so as to promote the permeation of water molecules out of the hydrogel and to obtain produced water after desalination.

2. The ammonia-driven hydrogel dehydration-desalination method according to claim 1, wherein:
the hydrogel is a poly(acrylic acid-co-acrylamide) hydrogel; and
the poly(acrylic acid-co-acrylamide) hydrogel is synthesized by an in-situ solution polymerization method.

3. The ammonia-driven hydrogel dehydration-desalination method according to claim 2, wherein reaction conditions for synthesizing the hydrogel are as follows:
concentrations of monomers: acrylic acid: 140-160 g/L, and acrylamide: 20-30 g/L;
a concentration of a crosslinking agent: N,N′-methylene diacrylamide: 0.03-0.04 g/L;
a concentration of an initiator: ammonium persulfate: 0.1-0.2 g/L;
a reaction time: 4 h;
a reaction temperature: 70° C.; and
a neutralization degree of the acrylic acid monomer: 60 mol %.

4. The ammonia-driven hydrogel dehydration-desalination method according to claim 2, wherein in the ammonia dehydration step, a salt rejection rate of 60% or above is achieved through electrostatic repulsion of carboxylate ions in the hydrogel.

5. The ammonia-driven hydrogel dehydration-desalination method according to claim 1, wherein in the ammonia dehydration step, the ammonia is introduced at a rate of 1 L/min; and
the ammonia is introduced for a time of 30 min.

6. The ammonia-driven hydrogel dehydration-desalination method according to claim 5, wherein in the ammonia dehydration step, a water recovery rate is higher than 90%.

7. The ammonia-driven hydrogel dehydration-desalination method according to claim 1, wherein the salt water is water with a salt concentration of 15-30 g/L or real seawater.

8. The ammonia-driven hydrogel dehydration-desalination method according to claim 7, wherein in the ammonia-driven hydrogel dehydration-desalination method, the hydrogel is soaked in water with a salt concentration of 15 g/L, and the maximum water production in the ammonia dehydration step is 1,140 L_{H2O}/kg_{hydrogel}/day.

9. The ammonia-driven hydrogel dehydration-desalination method according to claim 7, wherein in the ammonia-driven hydrogel dehydration-desalination method, the hydrogel is soaked in water with a salt concentration of 30 g/L, and the maximum water production in the ammonia dehydration step is 600 L_{H2O}/kg_{hydrogel}/day.

10. The ammonia-driven hydrogel dehydration-desalination method according to claim 1, wherein the ammonia-driven hydrogel dehydration-desalination method is integrated with a reverse osmosis system to achieve a seawater desalination process.

11. The ammonia-driven hydrogel dehydration-desalination method according to claim 1, wherein the salt water is a sodium chloride solution with a salt concentration of 15-30 g/L or real seawater.

12. The ammonia-driven hydrogel dehydration-desalination method according to claim 1, wherein in the ammonia dehydration step, the resulting produced water after desalination is used for plant irrigation.

13. The ammonia-driven hydrogel dehydration-desalination method according to claim 1, wherein in the ammonia dehydration step, the resulting produced water after desalination is used for integration with reverse osmosis process.
